(19) United States
(12) Patent Application Publication
(10) Pub. No.: US 2020/0031540 A1
(43) Pub. Date: Jan. 30, 2020

(54) Child-Resistant Closure

(71) Applicant: PLASTEK INDUSTRIES, INC., Erie, PA (US)

(72) Inventors: Timothy C. DZURIK, Erie, PA (US); Alex S. SZEKELY, Jackson, NJ (US)

(73) Assignee: Plastek Industries, Inc., Erie, PA (US)

(21) Appl. No.: 16/337,696

(22) PCT Filed: Oct. 26, 2017
(86) PCT No.: PCT/US2017/058471

§ 371 Date: Mar. 28, 2019

Related U.S. Application Data
(60) Provisional application No. 62/415,040, filed on Oct. 31, 2016.

(51) Int. Cl. B65D 50/06; A61J 1/03; B65D 1/02

(52) U.S. Cl. CPC B65D 50/061; B65D 2215/04; B65D 1/0223; A61J 1/03

(57) ABSTRACT

A closure (24) comprises: a base (50) for mounting to a container body neck; a cover (52); and a hinge (54) coupling the cover to the base. The base comprises: an inner sidewall (60) bearing a feature (140) for engaging the neck; an outer sidewall (62) spaced apart from the inner sidewall; an upper web (64) coupling the inner sidewall to the outer sidewall; and a first aperture (150) in the upper web. The cover comprises a latching tab (92). The cover has a closed condition wherein the latching tab extends into the first aperture in the upper web.

### CROSS-REFERENCE TO RELATED APPLICATION

Benefit is claimed of U.S. Patent Application No. 62/415,040, filed Oct. 31, 2016, and entitled “Child-Resistant Closure”, the disclosure of which is incorporated by reference herein in its entirety as if set forth at length.

### BACKGROUND

The disclosure relates to container closures. More particularly, the disclosure relates to child-resistant closures.

Among numerous examples of child-resistant closures for small over-the-counter (OTC) medications (e.g., pills, capsules, tablets) is U.S. Pat. No. 5,671,853 of Herr, issued Sep. 30, 1997. Herr discloses one particular screw-on closure.

### SUMMARY

One aspect of the disclosure involves a closure comprising: a base for mounting to a container body neck; a cover; and a hinge coupling the cover to the base. The base comprises: an inner sidewall bearing a feature for engaging the neck; an outer sidewall spaced apart from the inner sidewall; an upper web coupling the inner sidewall to the outer sidewall; and a first aperture in the upper web. The cover comprises a latching tab. The cover has a closed condition wherein the latching tab extends into the first aperture in the upper web.

In one or more embodiments of any of the foregoing embodiments, the base, cover, and hinge are unitarily molded as a single piece.

In one or more embodiments of any of the foregoing embodiments, the base, cover, and hinge are molded plastic.

In one or more embodiments of any of the foregoing embodiments, a container comprises the closure and further comprises a container body having a neck to which the base is mounted.

In one or more embodiments of any of the foregoing embodiments, the cover latching tab has a latching surface engaged to a latching surface of a projection of the neck in the closed condition.

In one or more embodiments of any of the foregoing embodiments, the base inner sidewall has a projection having a surface engaged to the latching surface of the neck projection to resist longitudinal removal of the base from the neck.

In one or more embodiments of any of the foregoing embodiments, the base outer sidewall has one or more first features and the body has one or more second features cooperating with the base outer sidewall first features in a locked condition to resist relative rotation of the body and closure.

In one or more embodiments of any of the foregoing embodiments, the base outer sidewall is inwardly compressible to facilitate disengagement of the one or more first features from the one or more second features to permit relative rotation of the body and closure from the locked condition to an unlocking condition.

In one or more embodiments of any of the foregoing embodiments, in the unlocking condition, the cover latching tab is registered with a partial radial recess in the neck projection.

In one or more embodiments of any of the foregoing embodiments, the container further comprises a plurality of pills, tablets, capsules, or gellcaps in the container body.

In one or more embodiments of any of the foregoing embodiments, said plurality of pills, tablets, capsules, or gellcaps in the container body are multivitamins.

In one or more embodiments of any of the foregoing embodiments, a method for using the container comprises compressing the base outer sidewall from the closed condition; rotating the closure from a first orientation to a second orientation relative to the body; and rotating the cover about a hinge axis to an open condition.

In one or more embodiments of any of the foregoing embodiments, the method further comprises pulling a latching tab of the cover.

In one or more embodiments of any of the foregoing embodiments, the inwardly pressing radially outwardly shifts a first feature of the closure base outer sidewall initially engaged to a second feature of the body.

Another aspect of the disclosure involves a container comprising: a container body having a neck; and a closure. The closure comprises: a base mounted to the container body neck; a cover; and a hinge coupling the cover to the base. The base comprises: an inner sidewall; an outer sidewall spaced apart from the inner sidewall; an upper web coupling the inner sidewall to the outer sidewall; an aperture in the upper web; and first and second apertures in the outer sidewall. The base inner sidewall bears a feature for engaging a feature of the neck to resist extraction of the base from the neck. The base outer sidewall bears one or more first features. The body bears one or more second features cooperating with the one or more first features to resist relative rotation of the closure and body in a locked condition.

Another aspect of the disclosure involves a method for opening a closure of a container from a closed condition to an open condition. The closure comprises: a base mounted to a neck of a body of the container; a cover having a latching tab; and a hinge coupling the cover to the base. The method comprises: compressing the base sidewall from the closed condition; rotating the closure from a first orientation to a second orientation relative to the body; and rotating the cover about a hinge axis to the open condition.

In one or more embodiments of any of the foregoing embodiments, in the closed condition, one or more first features of the base interfit with one or more second features of the body to resist relative rotation and the compressing radially outwardly shifts the first features.

In one or more embodiments of any of the foregoing embodiments, the compressing comprises contacting two circumferentially-spaced portions of the base sidewall respectively with a thumb and another finger of a given hand of a user.

In one or more embodiments of any of the foregoing embodiments, the rotating the cover comprises said user pulling a respective first and second tabs of the cover with said thumb and said another finger.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a first view of a container having a closure in an open condition.

FIG. 2 is a second view of the container.

FIG. 3 is a side view of the container.

FIG. 4 is a top view of the container.

FIG. 5 is a bottom view of the container.

FIG. 6 is a central longitudinal/vertical sectional view of the container taken along lines 6-6 of FIG. 4.

FIG. 7 is a cutaway view of the container with the closure in a closed condition.

FIG. 8 is a central longitudinal/vertical sectional view of the container taken along line 8-8 of FIG. 7.

FIG. 8A is an enlarged view of a latch region of the container of FIG. 8.

FIG. 9 is a view of the closed closure.

FIG. 10 is a side view of the closed closure.

FIG. 11 is a bottom of the closed closure.

FIG. 12 is a first view of a body of the container.

FIG. 13 is a second view of the body of the container.

Like reference numbers and designations in the various drawings indicate like elements.

### DETAILED DESCRIPTION

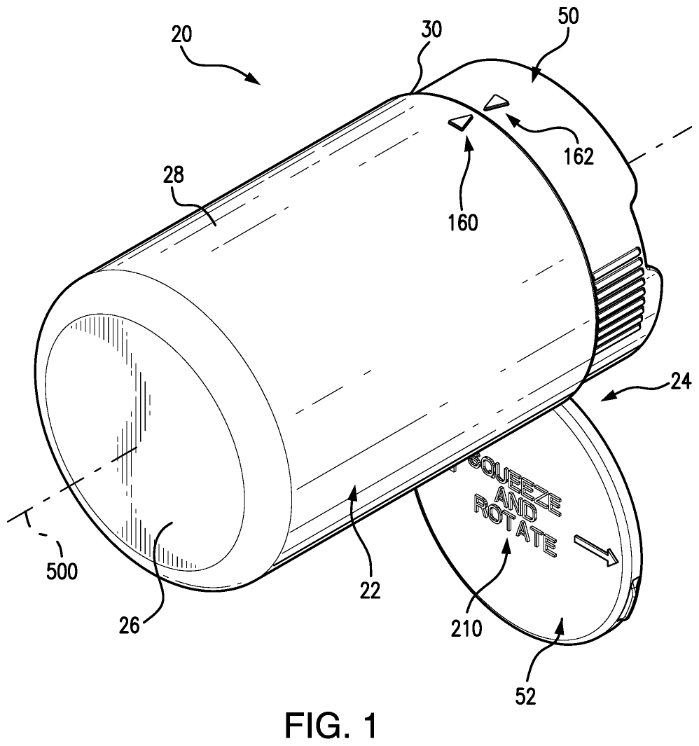

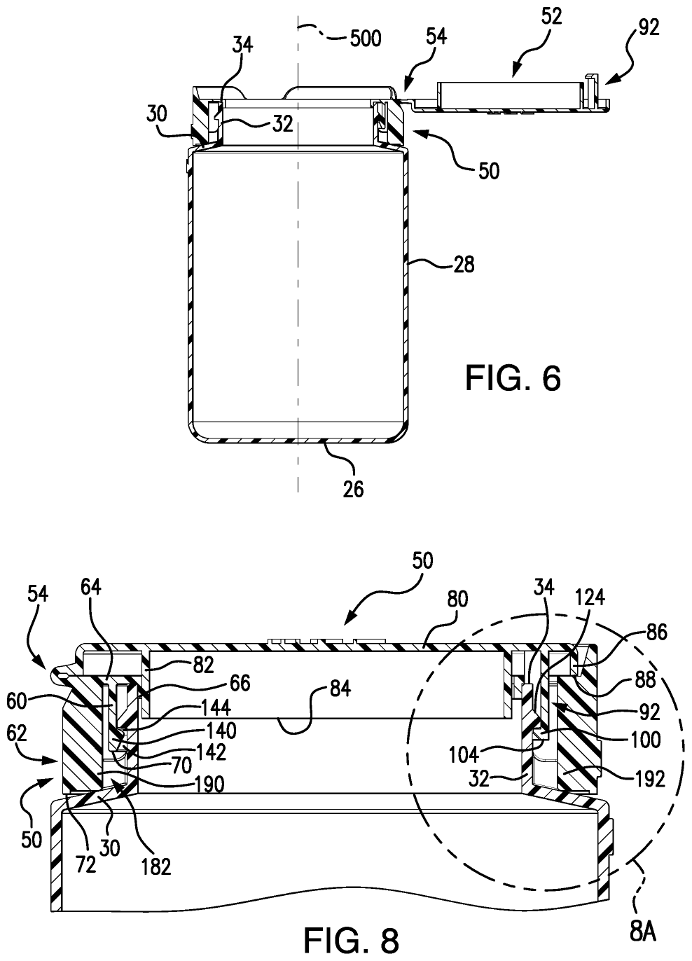

FIG. 1 shows a container 20 comprising a container body 22 and a closure 24. The exemplary body 22 (FIG. 6) comprises a bottom or base 26 and a sidewall 28 extending upward from the base. The exemplary side wall encircles a central longitudinal axis 500 (FIG. 6) which is a vertical axis when the bottle is in an upright condition.

The sidewall extends up to a shoulder 30 which, in turn, extends to a neck 32 extending to a rim 34 defining a mouth 36 of the body. The exemplary body comprises a single molded piece (e.g., injection blow molded) of a plastic material such as polyethylene terephthalate (PET) or polypropylene (PP).

The exemplary closure 24 is also formed of a single molded piece (e.g., injection molded) of plastic such as co-polymer polypropylene (COPP). The closure may be molded in an open condition. The exemplary closure comprises a base 50 and a lid or cover 52 coupled to the base via a living hinge 54. As is discussed below, the base bears features for mounting to the body (e.g., snap features).

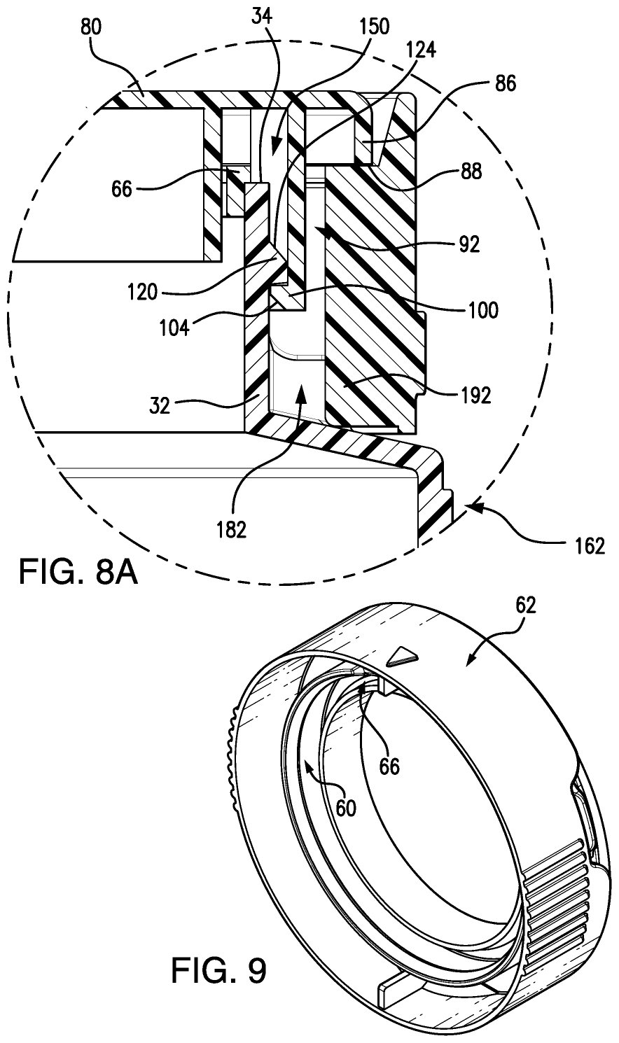

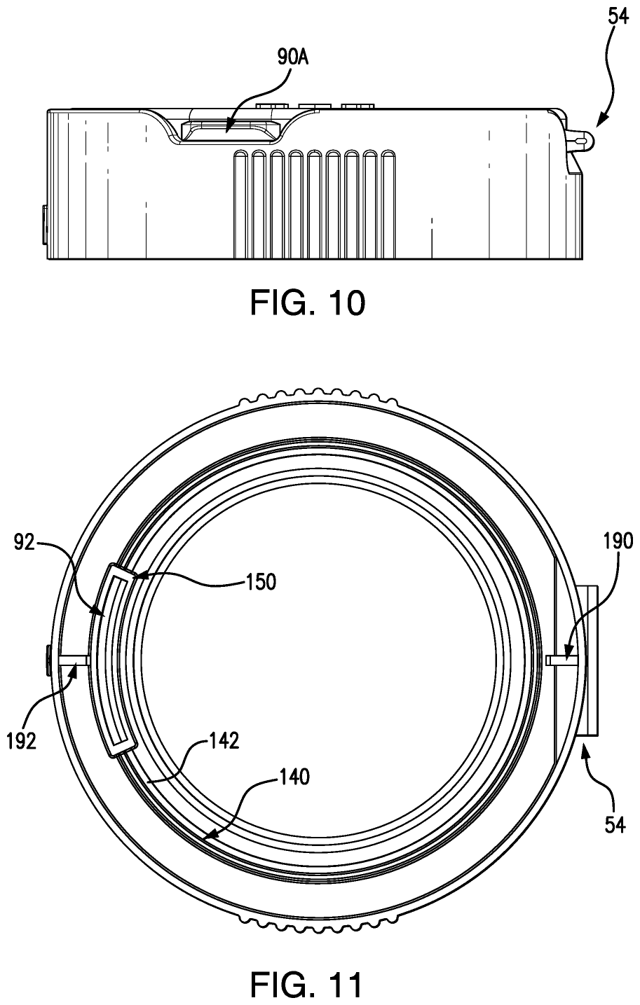

The base has an inner sidewall 60 (FIG. 8) and an outer sidewall 62. The inner sidewall 60 bears the features for mounting to the body neck. The inner sidewall 60 and outer sidewall 62 respectively extend upward from lower rims 70 and 72. The exemplary rim 70 is vertically recessed relative to the rim 72.

The sidewalls 60 and 62 extend upward to an upper web or flange 64 coupling the inner sidewall to the outer sidewall 62. The exemplary web 64 extends radially inward past the inner sidewall 60 to a short vertical wall or boss 66 depending from the web 64 at a central opening thereof.

The cover 50 comprises a transverse web 80 with a central sidewall or collar 82 depending from the underside of the web 80 to a lower rim 84. In the closed position, the sidewall 82 is received within the boss 66 in a tight sealing relation. The cover 50 also comprises an outer or outboard sidewall or collar 86 depending from the outboard periphery of the web 80 to a lower rim 88.

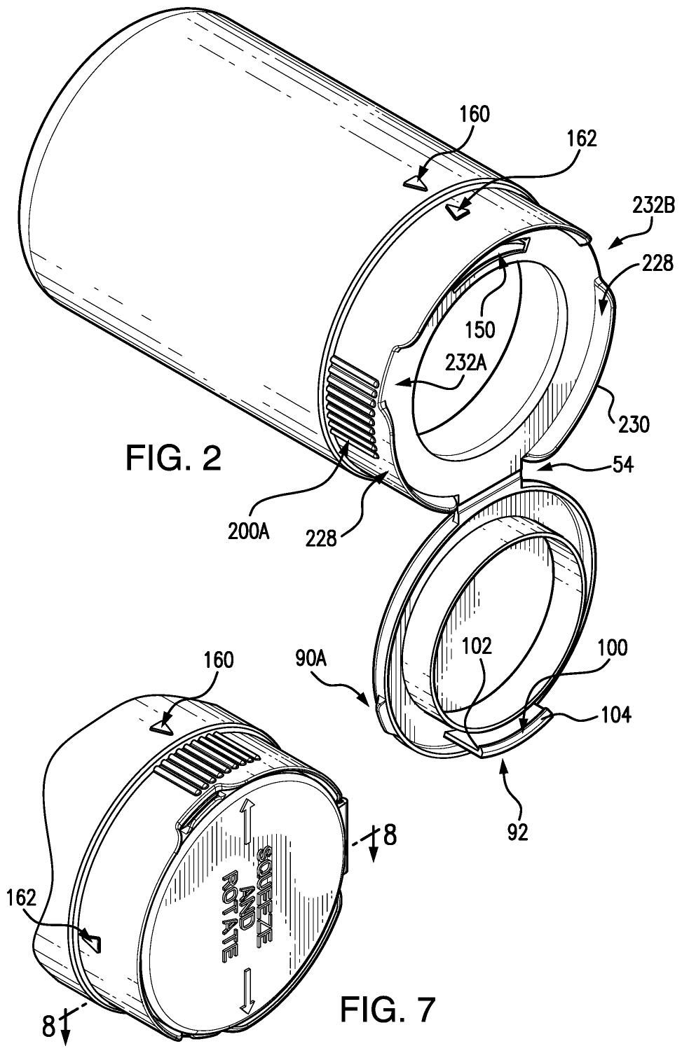

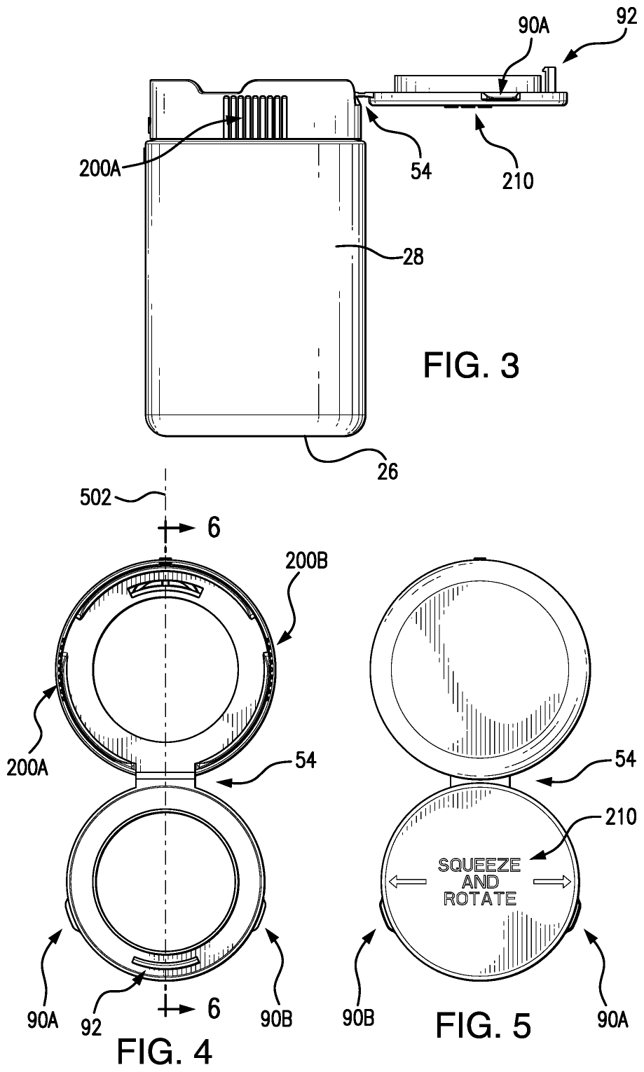

FIGS. 2 and 4 show the cover 50 including three tabs 90A, 90B, and 92. Exemplary tabs 90A and 90B extend radially outward (e.g., from the outer sidewall 86). The tab 92 is opposite the hinge 54 and bears an interior latching projection 100 (FIG. 2) having a locking/latching surface 102 and a camming surface 104. This projection 100 cooperates with a projection 120 (FIG. 13) on the neck having a locking/latching surface 122 and a camming surface 124.

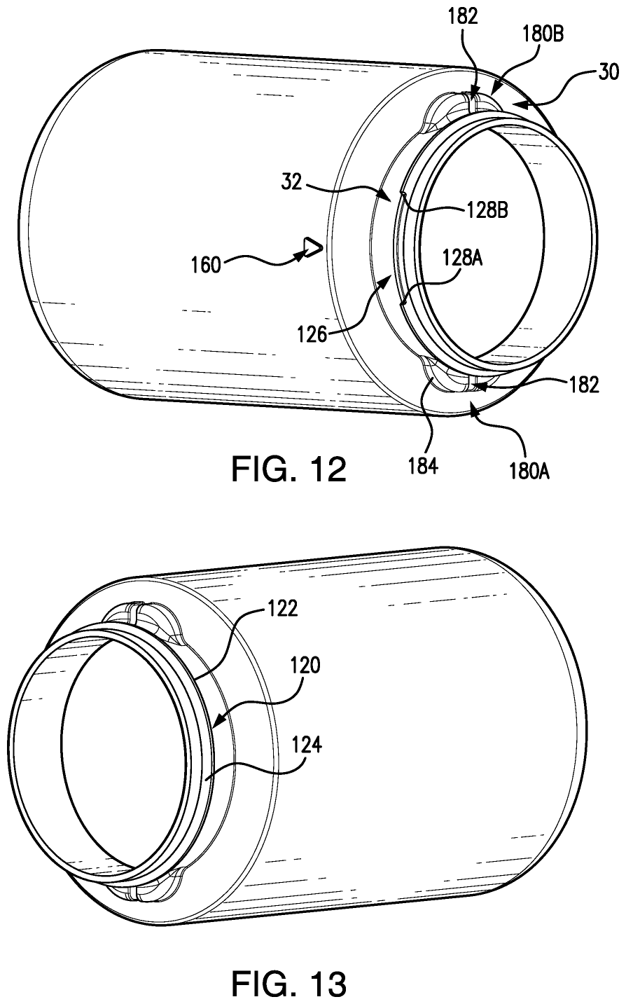

As is discussed further below, the projection 120 has a partial depth gap or radial recess 126 (FIG. 12) extending along a sector between a first end 128A and a second end 128B. With the closure in a closed condition, rotation of the closure relative to the body about the axis 500 shifts the closure between one or more locked conditions and an unlocking condition. In the unlocking condition, the tab 92 is registered with the gap 126. In the exemplary embodiment, the gap 126 is only partial radial depth of the projection 120. Accordingly, rotation to this unlocking condition (orientation) will still leave the closure in a closed condition. However, the reduced depth of the projection at the gap allows the tab to be shifted radially outward (as discussed below) enough to disengage from the projection and be rotated about the hinge axis 510 to an open condition. Thus, the unlocking condition is more of a detented condition than a latched condition (discussed below).

In the exemplary closed condition of the closure, the tab 92 extends longitudinally through an aperture or opening 150 in the base web 64.

Similarly, when the closure is in the unlocking orientation relative to the body, the cover may be closed from the open condition of FIG. 2 by hinging about the axis of the hinge 54, the camming surfaces 104 and 124 eventually engage each other to radially outwardly shift the tab 92 briefly until the projections pass over each other. Thereafter, the tab 92 relaxes radially inward and the surfaces 102 and 122 abut and backlock to resist extraction/removal of the closure. The closure may then be rotated back from the unlocking orientation to the locked condition.

The closure base 50 mounts the container body. Exemplary mounting is via snap engagement. Exemplary snap engagement also utilizes the projection 120 as a snap feature. To interface with the projection 120, the inner sidewall 60 (FIG. 8) contains a radially-inwardly protruding projection 140 having a camming surface 142 and a locking surface 144. FIG. 11 shows the projection 140 as having a gap formed at the opening 150 in the web 64 positioned to pass and accommodate the projection 92 in the closed condition.

The projection 140 is of sufficient circumferential extent to always be engaged to an intact portion of the projection 120 (i.e., away from the gap 126) so that it will be very difficult or impractical if not impossible to pull off the closure base 50 once installed regardless of orientation relative to the container body. Accordingly, it is seen that by rotating the closed closure into the unlocking orientation, the closure may be opened. To indicate that the closure is in the unlocking orientation, the body and closure may have respective indicia (e.g., molded-in) 160 and 162 (FIG. 1). The exemplary indicia are arrows which circumferentially align/register with each other in the unlocking orientation.

Means may be provided for detenting or more robustly locking a locked orientation. The exemplary locked orientation represents a relative rotation of closure and base away from the unlocking orientation. In the exemplary implementation, two specific locked orientations are provided at plus/minus 90° relative rotation. This is provided by features 180A, 180B (FIG. 12) on the body which may cooperate with features 190 and 192 (FIG. 11) of the closure base. The exemplary features 180A and 180B are bosses protruding along a junction between the shoulder 30 and neck 32 and having a central gap 182 which may accommodate the features 190 and 192. Thus, in the exemplary embodiment, the gaps 182 are diametrically opposite each other and the features 190 and 192 are formed as inward radial projections from the base outer sidewall 62, more particularly, vertical fins protruding inward from the sidewall 62 and downward from the web 64 (FIG. 8).

It is thus seen that to rotate the closure from the locked orientation to the unlocking orientation, the fins 190 and 192 must be disengaged from the associated bosses. This disengagement may be achieved by radially inwardly compressing the closure base outer sidewall 62 transversely. This transverse compression will cause the sidewall to shift radially outward at the fins allowing fin disengagement from the bosses. FIGS. 2 and 4 show contouring 200A and 200B along the outer surface of the base outer sidewall on opposite sides of a plane 502 to help with such transverse compression.

FIG. 5 shows molded-in indicia 210 on the upper surface of the lid providing instructions to compress or squeeze at these locations and then rotate the closure. Once rotated to the unlocking condition, the user may pull up on the tabs 90A and 90B to overcome the reduced required forces to disengage the projection 92 when it is at the gap 126, allowing the lid to be opened by rotation about the hinge axis. In the exemplary embodiment, to highlight the presence of the tabs 90, the outer sidewall of the base has a portion 228 protruding upward from the web 64 to an upper rim 230 (FIG. 2). This portion has gaps 232A and 232B for accommodating the tabs 90A and 90B when the lid is closed. The upwardly protruding wall portion also allows the remainder of the lid to sit generally flush when closed.

As noted above, to close the closure, the lid may be rotated back about the hinge axis with the projection 92 passing through the opening 150 and the projection 100 ultimately reengaging the projection 120 at the gap 126. Thereafter, the closed closure may be rotated back to the locking condition. In the exemplary embodiment, the bosses (FIG. 12) have tapering circumferential surfaces 184 on opposite sides to guide the fins radially outward until the fins reach the gaps 182 and snap into said gaps to lock the closure in the locked orientation.

Child-resistance may come from a combination of factors which may vary across embodiments. One factor is complexity of manipulation. The exemplary embodiment requires three distinct actions: lateral compression of the base outer sidewall; rotation of the closure while at least initially maintaining that compression; stopping rotation at the specific unlocking orientation (in this example there is no detenting of the unlocking orientation so that even if a child got that far, there is a substantial chance of over-rotation out of the unlocking orientation before any further steps might be taken); and, when in the unlocking orientation, pulling up by the tabs 90A and 90B to unlatch the tab 92.

Size also is relevant. For single handed release, the user's hand must be large enough span the diameter of the top of the closure and allow the engaging fingers (e.g., thumb plus forefinger or another finger) to reach down to the sidewall portions 200A and 200B. Exemplary diameters are 60 mm to 70 mm, more broadly 50 mm to 80 mm. Required force (which may be controlled by selection of material thickness, etc.) is also a factor. Depending on the nature of the products being dispensed, different levels of child-resistance may be required. For example, some vitamins may be subject to no regulatory requirement for child-resistant containers. A variation offering less resistance may be acceptable with these. At the other end of the spectrum, some variations may be sufficient for prescription drugs for which a higher level of child resistance may be required.

The use of “first”, “second”, and the like in the description and following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

One or more embodiments have been described. Nevertheless, it will be understood that various modifications may be made. For example, when applied to an existing basic system, details of such configuration or its associated use may influence details of particular implementations. Accordingly, other embodiments are within the scope of the following claims.

1. A container comprising:
a container (22) body having a neck (32); and
closure (24) comprising:
a base (50) for mounting to a container body neck;
a cover (52); and
a hinge (54) coupling the cover to the base,
wherein:
the base comprises:
an inner sidewall (60) bearing a feature (140) for engaging the neck;
an outer sidewall (62) spaced apart from the inner sidewall;
an upper web (64) coupling the inner sidewall to the outer sidewall; and
a first aperture (150) in the upper web;
the cover comprises:
a latching tab (92); and
the cover has a closed condition wherein:
the latching tab extends into the first aperture in the upper web;
the cover latching tab has a latching surface (102) engaged to a latching surface of a projection (120) of the neck in the closed condition;
the base outer sidewall has one or more first features;
the body has one or more second features cooperating with the base outer sidewall first features in a locked condition to resist relative rotation of the body and closure.
the base outer sidewall is inwardly compressible to facilitate disengagement of the one or more first features from the one or more second features to permit relative rotation of the body and closure from the locked condition to an unlocking condition.

2. The container of claim 1 wherein:
the base, cover, and hinge are unitarily molded as a single piece.

3. The container of claim 1 wherein:
the base, cover, and hinge are molded plastic.

4. (canceled)

5. (canceled)

6. The container of claim 1 wherein:
the base inner sidewall has a projection (140) having a surface engaged to the latching surface of the neck projection to resist longitudinal removal of the base from the neck.

7. (canceled)

8. (canceled)

9. The container of claim 1 wherein:
in the unlocking condition, the cover latching tab is registered with a partial radial recess in the neck projection.

10. The container of claim 1 further comprising:
a plurality of pills, tablets, capsules, or gellcaps in the container body.

11. The container of claim 10 wherein:
said plurality of pills, tablets, capsules, or gellcaps in the container body are multivitamins.

12. A method for using the container of claim 1, the method comprising:
compressing the base outer sidewall from the closed condition;
rotating the closure from a first orientation to a second orientation relative to the body; and
rotating the cover about a hinge axis to an open condition.

13. The method of claim 12 further comprising:
pulling a latching tab of the cover.

14. The method of claim 12 wherein:
the inwardly pressing radially outwardly shifts a first feature of the closure base outer sidewall initially engaged to a second feature of the body.

15. A container comprising:
a container body having a neck; and
a closure (24) comprising:
a base (50) mounted to the container body neck;
a cover (52); and
a hinge (54) coupling the cover to the base,
wherein:
the base comprises:
an inner sidewall (60);
an outer sidewall (62) spaced apart from the inner sidewall;
an upper web (64) coupling the inner sidewall to the outer sidewall;
an aperture in the upper web; and
first and second apertures in the outer sidewall;
the base inner sidewall bears a feature (140) for engaging a feature (120) of the neck to resist extraction of the base from the neck;
the base outer sidewall bears one or more first features (180A, 180B);
the body bears one or more second features (182) cooperating with the one or more first features to resist relative rotation of the closure and body in a locked condition.

16. A method for opening a closure (24) of a container (20) from a closed condition to an open condition, the closure comprising:
a base (50) mounted to a neck of a body (22) of the container;
a cover (52) having a latching tab; and
a hinge (54) coupling the cover to the base,
the method comprising:
compressing a base sidewall (62) from the closed condition;
rotating the closure from a first orientation to a second orientation relative to the body; and
rotating the cover about a hinge axis to the open condition.

17. The method of claim 16 wherein:
in the closed condition, one or more first features of the base interfit with one or more second features of the body to resist relative rotation; and
the compressing radially outwardly shifts the first features.

18. The method of claim 16 wherein:
the compressing comprises contacting two circumferentially-spaced portions of the base sidewall respectively with a thumb and another finger of a given hand of a user.

19. The method of claim 18 wherein the rotating the cover comprises:
said user pulling a respective first and second tabs of the cover with said thumb and said another finger.
